(19) United States
(12) Patent Application Publication
(10) Pub. No.: US 2015/0130846 A1
(43) Pub. Date: May 14, 2015

(54) ELECTRONIC DEVICE, METHOD, AND COMPUTER PROGRAM PRODUCT

(71) Applicant: Kabushiki Kaisha Toshiba, Tokyo (JP)

(72) Inventors: Mieko Asano, Kawasaki-shi (JP); Sumi Omura, Mitaka-shi (JP); Masatoshi Murakami, Hamura-shi (JP); Toshio Ariga, Tokyo (JP); Masanori Sekine, Ome-shi (JP); Sumihiko Yamamoto, Ome-shi (JP)

(21) Appl. No.: 14/333,903

(22) Filed: Jul. 17, 2014

(30) Foreign Application Priority Data
Nov. 8, 2013 (JP) 2013-232376

(51) Int. Cl. G06F 3/01; G06T 3/40

(52) U.S. Cl. CPC G06F 3/017; G06T 3/40
USPC 345/661

(57) ABSTRACT

According to one embodiment, an electronic device includes a receiver and a display controller. The receiver is configured to receive an image acquired by a camera. The display controller is configured to display an image received by the receiver at a first display magnification, and to display, if a first image received by the receiver comprises both an image of a hand and an image of a region in a face, the first image at a second display magnification higher than the first display magnification.

### CROSS-REFERENCE TO RELATED APPLICATIONS

This application is based upon and claims the benefit of priority from Japanese Patent Application No. 2013-232376, filed Nov. 8, 2013, the entire contents of which are incorporated herein by reference.

### FIELD

Embodiments described herein relate generally to an electronic device, a method, and a computer program product.

### BACKGROUND

Conventionally, there is provided an electronic device that can be used like a mirror by displaying image data acquired by a camera on a display device.

According to the conventional technique in which the electronic device can be used like a mirror, the size of the image data is enlarged and reduced using digital zoom, etc., when a user's operation is received. However, it is often the case that both hands of the user are occupied at the time when the user is wearing a contact lens or making up. In such a case, the user confronts difficulty in performing designation of areas.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view of a television broadcasting display device according to an embodiment;

FIG. 2 is an exemplary block diagram of a hardware configuration of the television broadcasting display device in the embodiment;

FIG. 3 is an exemplary block diagram of a configuration realized by executing a group of control programs in a controller of the television broadcasting display device in the embodiment;

FIG. 4 is an exemplary diagram of positional relation between a region in a face and a hand detected from image data with a detector of the television broadcasting display device in the embodiment;

FIG. 5 is an exemplary diagram of positional relation between a region in a face and a hand detected from image data with a detector of the television broadcasting display device in the embodiment;

FIG. 6 is an exemplary diagram of a configuration of an enlargement control database of the television broadcasting display device in the embodiment;

FIG. 7 is an exemplary flowchart of processing of enlarging and displaying image data in the television broadcasting display device in the embodiment; and

FIG. 8 is an exemplary flowchart of processing of determining whether image data is to be enlarged in the television broadcasting display device in the embodiment.

### DETAILED DESCRIPTION

In general, according to one embodiment, an electronic device comprises a receiver and a display controller. The receiver is configured to receive an image acquired by a camera. The display controller is configured to display an image received by the receiver at a first display magnification, and to display, if a first image received by the receiver comprises both an image of a hand and an image of a region in a face, the first image at a second display magnification higher than the first display magnification.

The following embodiment will exemplify a case of the television broadcasting display device to which the electronic device of the invention is applied. However, the following embodiment does not limit the electronic device to a television broadcasting display device, and any electronic device can be applied as long as it displays image data acquired by an image acquiring module on a display.

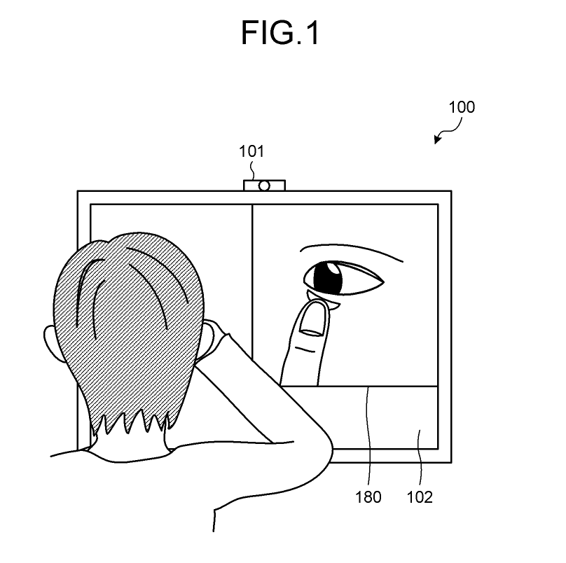

FIG. 1 is a schematic view illustrating a television broadcasting display device according to an embodiment. As illustrated in FIG. 1, a television broadcasting display device 100 comprises a camera 101, and displays image data acquired by the camera 101 on an image display panel 102. The television broadcasting display device 100 detects a face or a hand of a person from acquired image data, and enlarges and displays the face when the person performs operation on the face, etc.

For example, the television broadcasting display device 100 enlarges and displays an area containing an eye when the user is wearing a contact lens on the eye, or enlarges and displays an area containing an eyebrow, etc., when the user is applying makeup onto the eyebrow, etc. The control of enlarging and reducing image data, etc., may be performed using, for example, a remote controller (not illustrated) of the television broadcasting display device 100. However, it is difficult for the user holding a contact lens, a cosmetic product, etc., in his/her hand to hold other objects or operate the television broadcasting display device 100. Thus, in the embodiment, the television broadcasting display device 100 performs control of enlargement and reduction based on the positional relation between a face and a hand (or an object such as a cosmetic product).

In the television broadcasting display device 100 of the embodiment, a partial area 180 of the image display panel 102 is used to display image data acquired by the camera 101. In this manner, the user can perform operation while viewing a program, etc., on another area of the image display panel 102. The content displayed on another area is not limited to a program, and the entire of image data acquired by the camera 101 may be displayed. The embodiment does not limit the display form, and the entire area of the image display panel 102 may be used to display image data.

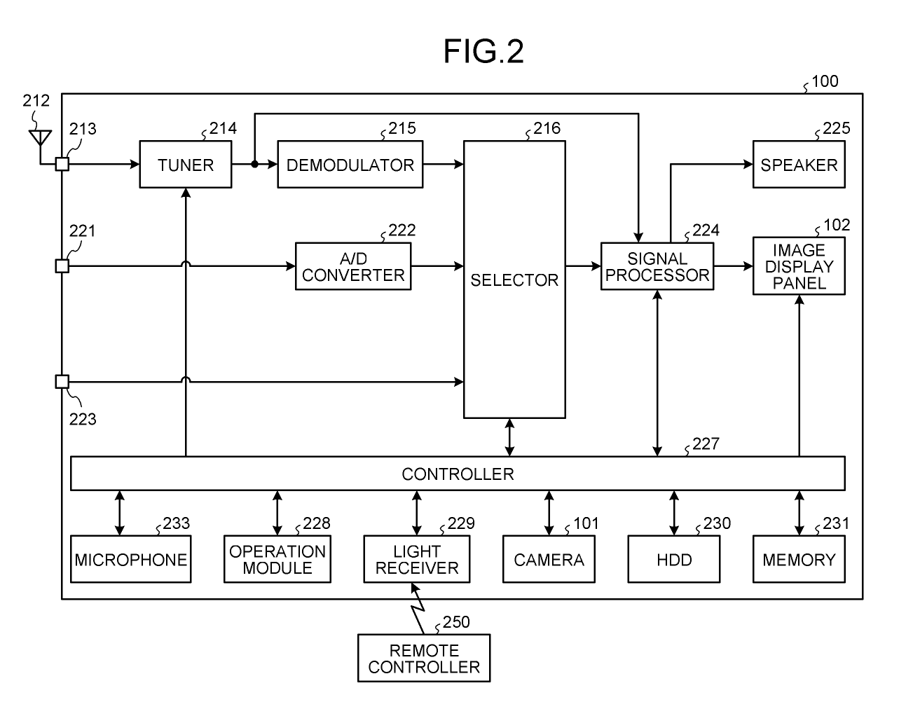

FIG. 2 is a block diagram illustrating an example of a hardware configuration of the television broadcasting display device 100 in the embodiment. The television broadcasting display device 100 is an image display device that receives digital broadcasting and displays images of a program using image signals extracted from the received broadcasting.

The television broadcasting display device 100 comprises an antenna 212, an input terminal 213, a tuner 214, and a demodulator 215. The antenna 212 receives digital broadcasting, and supplies broadcast signals of the broadcasting to the tuner 214 through the input terminal 213.

The tuner 214 selects broadcast signals of a desired channel from the input broadcast signals of digital broadcasting. The broadcast signals output from the tuner 214 are then supplied to the demodulator 215. The demodulator 215 performs demodulation processing on the broadcast signals so as to demodulate digital image signals and voice signals, and supplies the digital image signals and voice signals to a selector 216 described later.

The television broadcasting display device 100 also comprises input terminals 221 and 223, an analog-to-digital (A/D) converter 222, a signal processor 224, a speaker 225, and the image display panel 102.

Analog image signals and voice signals are input to the input terminal 221 from the outside, and digital image signals and voice signals are input to the input terminal 223 from the outside. The A/D converter 222 converts the analog image signals and voice signals supplied from the input terminal 221 into digital signals, and supplies the digital signals to the selector 216.

The selector 216 selects one of the digital image signals and voice signals supplied from the demodulator 215, the A/D converter 222, and the input terminal 223, and supplies the selected digital image signals and voice signals to the signal processor 224.

The signal processor 224 performs certain signal processing and scaling processing, etc., on the input image signals, and supplies the processed image signals to the image display panel 102. Moreover, the signal processor 224 performs certain signal processing on the input digital voice signals to convert them into analog voice signals, and outputs the analog voice signals to the speaker 225. The television broadcasting display device 100 also comprises at least a TS demultiplexer and a MPEG decoder, and signals decoded with the MPEG decoder are input to the signal processor 224.

Furthermore, the signal processor 224 also generates on screen display (OSD) signals to be displayed on the image display panel 102.

The speaker 225 receives the voice signals supplied from the signal processor 224 and outputs voice using the voice signals.

The image display panel 102 comprises a flat panel display such as a liquid crystal display and a plasma display. The image display panel 102 displays images using the image signals supplied from the signal processor 224.

Furthermore, the television broadcasting display device 100 comprises a controller 227, an operation module 228, a light receiver 229, a hard disk drive (HDD) 230, a memory 231, the camera 101, and a microphone 233.

The controller 227 integrally controls various kinds of operation of the television broadcasting display device 100. The controller 227 is a microprocessor mainly comprising a central processing unit (CPU), and receives operation information from the operation module 228 while receiving operation information transmitted from a remote controller 250 through the light receiver 229, thus controlling each module in accordance with such operation information. The light receiver 229 of the embodiment receives infrared from the remote controller 250.

The controller 227 uses the memory 231. The memory 231 mainly comprises a read only memory (ROM) storing control programs executed by the CPU embedded in the controller 227, a random access memory (RAM) for providing the CPU with a work area, and a nonvolatile memory storing various kinds of setting information and control information, etc.

The HDD 230 has a function as a recorder that records the digital image signals and voice signals selected with the selector 216. The television broadcasting display device 100 comprises the HDD 230, and thus can record the digital image signals and voice signals selected with the selector 216 in the HDD 230. The television broadcasting display device 100 also can reproduce images and voice using the digital image signals and voice signals recorded in the HDD 230.

The camera 101 functions as an image acquiring module that acquires an image of the front of the television broadcasting display device 100. The microphone 233 collects voice signals emitted by the user.

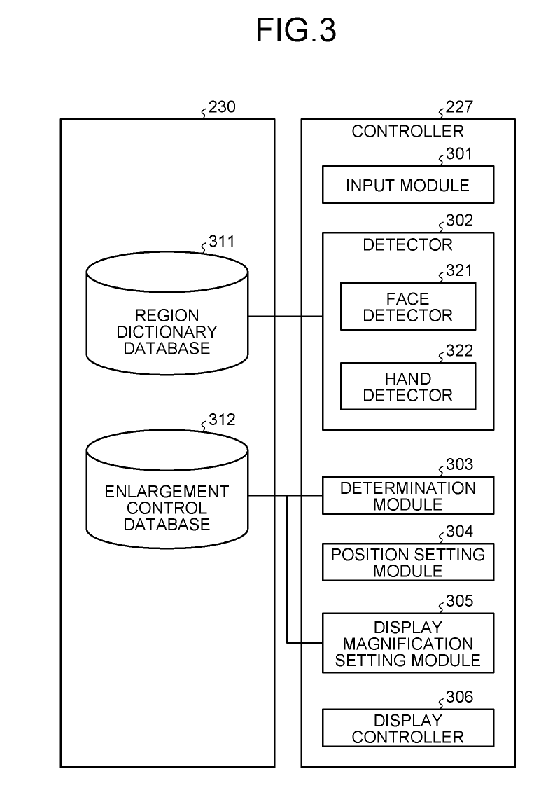

FIG. 3 is a block diagram illustrating an example of a configuration realized by executing a group of control programs in the controller 227. As illustrated in FIG. 3, the controller 227 achieves an input module 301, a detector 302, a determination module 303, a position setting module 304, a display magnification setting module 305, and a display controller 306. Each component of the controller 227 can refer to a region dictionary database 311 and an enlargement control database 312 that are stored in the HDD 230.

The region dictionary database 311 is a database that can be referred to as a dictionary for detecting a face or a hand. Characteristic information of a region in a face (eye, eyebrow, nose, mouth, etc.) is registered preliminarily in the region dictionary database 311 of the embodiment. The forms of a hand acquired by the camera 101 are also registered preliminarily in the region dictionary database 311. A hand can be detected with comparison with the registered forms of a hand. The embodiment does not limit the method of detecting a face or a hand, and other methods such as known methods may be used for such detection.

The input module 301 receives image data acquired by the camera 101. The input module 301 may also receive voice signals through the microphone 233, if necessary.

The detector 302 comprises a face detector 321 and a hand detector 322, and detects an acquired hand, face, object, etc., from the image data.

The face detector 321 detects the face of a person appearing on the image data received by the input module 301. As a method of detecting the face of a person, various methods such as known methods may be used. In the embodiment, characteristic information of each region in a face is preliminarily registered in the region dictionary database 311. Thus, the face detector 321 detects a face based on similarity between an image of the image data and the registered characteristic information. Moreover, the face detector 321 of the embodiment also detects each region (eyebrow, eye, nose, mouth, etc.) in a face.

The hand detector 322 detects a hand of a person appearing on the image data received by the input module 301 based on comparison with the form patterns of a hand registered in the region dictionary database 311. The hand detector 322 also detects, for example, an object (projection etc.) adjacent to a detected hand. The object (projection) adjacent to a hand may be an eyebrow pencil, etc.

The determination module 303 determines whether the image data is to be enlarged based on the positional relation between the face of a person detected with the face detector 321 and the hand detected with the hand detector 322. In the embodiment, a threshold is preliminarily set for each region in the face of a person. The determination module 303 determines that the image data is to be enlarged when a distance between each region in the face of a person and a hand or an object held in the hand is shorter than a predetermined threshold. The threshold is set depending on an embodiment, and thus the explanation thereof is omitted.

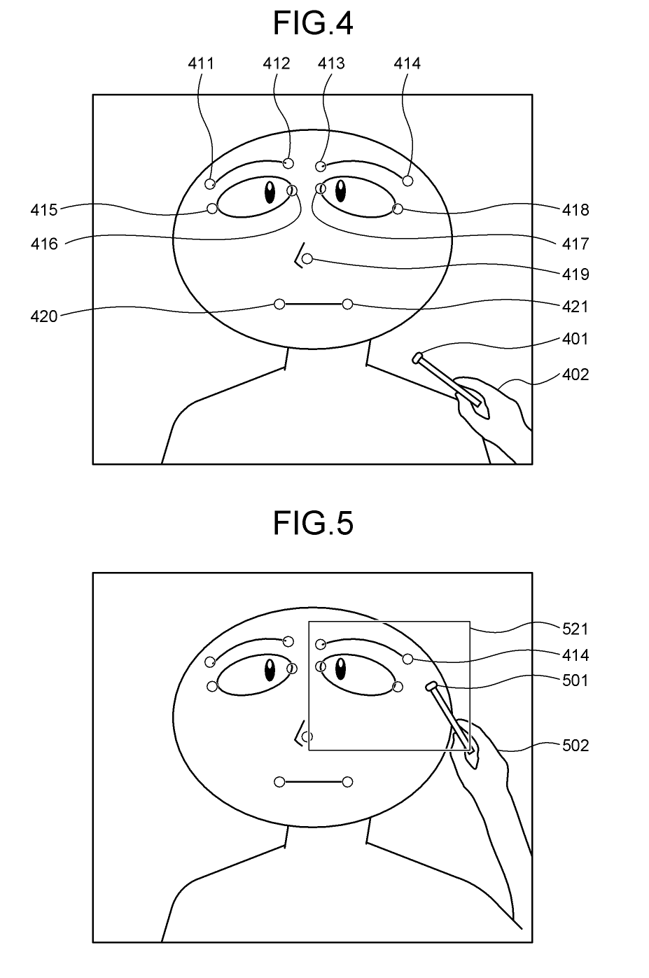

FIG. 4 is a diagram illustrating an example of the positional relation between a region in a face and a hand detected from image data with the detector 302. Parts 411 to 421 represented by “◯” of FIG. 4 are parts determined to be high in similarity with the characteristic information registered in the region dictionary database 311. Thus, the face detector 321 can detect a face. The face detector 321 can specify each region of a face based on the parts 411 to 421 determined to be high in similarity with the characteristic information. Furthermore, the hand detector 322 detects a hand 402, and a projection (considered to be a cosmetic product) 401 adjacent to the hand 402. In the example illustrated in FIG. 4, the determination module 303 determines that the image data is not to be enlarged because the distance between the region in a face and a fingertip of a hand or a tip of the projection 401 adjacent to the hand (held in the hand) is equal to or longer than a threshold.

FIG. 5 is a diagram illustrating positional relation between a region in a face and a hand detected from image data with the detector 302. In the example illustrated in FIG. 5, the determination module 303 determines that the image data is to be enlarged because the distance between an eyebrow in a face (part 414, for example) and a tip of a projection 501 adjacent to a hand 502 is shorter than a threshold. Thus, the display controller 306 enlarges and displays an area 521.

There may be a case in which distances between a plurality of regions and a hand (or a tip of an object adjacent to the hand) are short and it becomes unclear which of such regions is to be focused and enlarged. Thus, in the embodiment, the determination module 303 determines which region is to be focused based on the state of a hand. When the state of a hand is specified, the determination module 303 of the embodiment refers to the enlargement control database 312 and sets a region associated with such a state of a hand as an object to be focused.

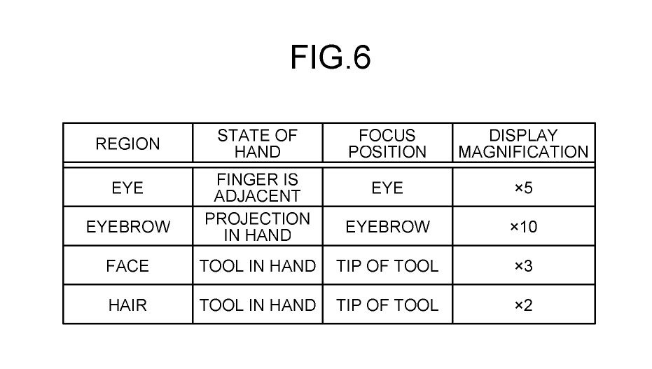

FIG. 6 is a diagram illustrating an example of a configuration of the enlargement control database 312. As illustrated in FIG. 6, a region, a state of a hand, a focus position, and a magnification are registered in an associated manner in the enlargement control database 312. As illustrated in FIG. 6, the state of a hand is registered for each region in a face. When the state of a hand registered for each region in a face matches the state of a hand detected with the detector 302, the determination module 303 determines that the region in a face associated with such a state of a hand is to be enlarged. The “projection in hand” associated with an eyebrow indicates a state in which an eyebrow pencil, etc., is held in a hand. Similarly, the “tool in hand” associated with a face indicates a state in which a shaver, etc., is held in a hand, and the “tool in hand” associated with hair indicates a state in which tweezers, etc., are held in a hand.

When the determination module 303 determines that the image data is to be enlarged, the position setting module 304 sets a focus position as a reference for enlargement on the image data received by the input module 301. In the embodiment, the position setting module 304 sets a focus position associated with a region to be enlarged in the enlargement control database 312 as a center position of focusing on the image data to be enlarged.

When the determination module 303 determines that the image data is to be enlarged, the display magnification setting module 305 sets a display magnification for the image data received by the input module 301. In the embodiment, the display magnification setting module 305 sets a display magnification associated with a region to be enlarged in the enlargement control database 312 as a display magnification for the image data to be enlarged. The embodiment exemplifies the case in which the image data is enlarged at a display magnification set in the enlargement control database 312. However, other methods may be used as a method of enlargement. For example, the display magnification setting module 305 may calculate a display magnification appropriate for displaying each region based on a size of a face, etc., in the image data, and set the calculated display magnification.

The display controller 306 displays the image data received by the input module 301 on the image display panel 102 at a normal display magnification. When the determination module 303 determines that the image data is to be enlarged, the display controller 306 of the embodiment enlarges and displays the image data with the center position of focusing set with the position setting module 304 and at the display magnification (higher than a normal display magnification) set with the display magnification setting module 305.

In this manner, the display controller 306 displays the image data received by the input module 301 on the image display panel 102 at a normal display magnification. When the displayed image data contains an image of a hand and a region in the face of a person, the display controller 306 displays the image data at a display magnification for enlarged display that is higher than a normal display magnification.

As described above, in the embodiment, the distance between a hand, etc., and a region in a face is considered when the display is switched. That is, the display controller 306 displays image data containing a hand and a region in a face at a normal display magnification when the distance between the hand and the region in the face is longer than a threshold preliminarily set for enlargement determination, and displays the image data containing the hand and the region in the face at a display magnification for enlarged display when the distance is equal to or smaller than the threshold preliminarily set for enlargement determination.

The threshold for enlargement determination may be set differently for each region in a face. For example, the HDD 230 stores the threshold for enlargement determination for each region in a face, and the determination module 303 determines whether the image containing the region is to be enlarged while referring to the HDD 230 and using the threshold for enlargement determination that is different depending on each region in a face. In this manner, when the distance between a hand and an eye in a face is shorter than a threshold set for the eye, the display controller 306 displays the image containing the hand and the eye at a display magnification associated with the eye. When the distance between a hand (or a projection) and an eyebrow in a face is shorter than a threshold set for the eyebrow, the display controller 306 displays the image containing the hand (or the projection) and the eyebrow at a display magnification associated with the eyebrow (that is different from the display magnification associated with the eye).

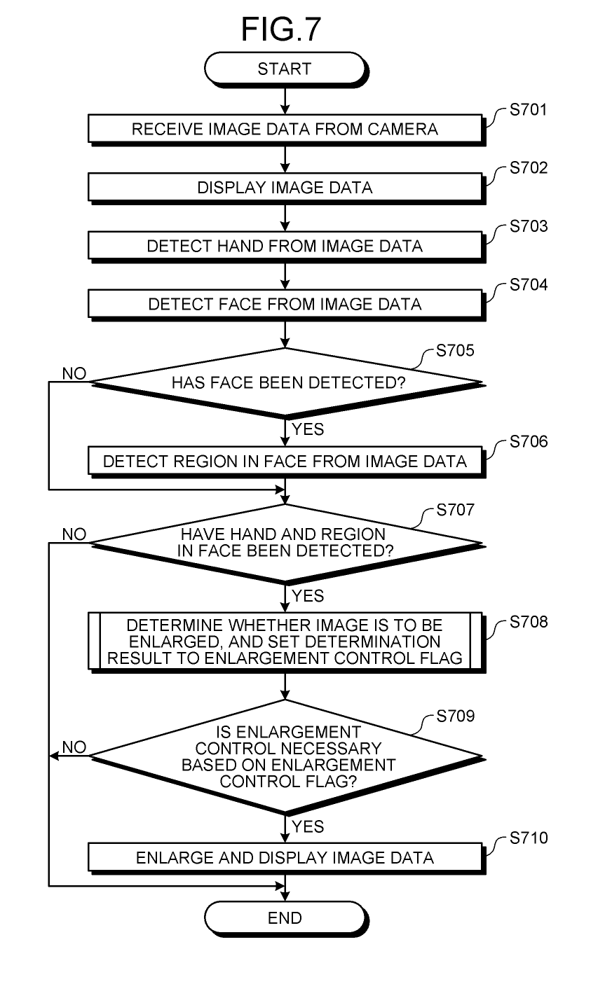

The following will describe the processing of enlarging and displaying image data in the television broadcasting display device 100 of the embodiment. FIG. 7 is a flowchart illustrating the above-mentioned processing in the television broadcasting display device 100 in the embodiment.

First, the input module 301 receives image data from the camera 101 (S701). Next, the display controller 306 displays the input image data on the image display panel 102 at a normal display magnification (S702).

The hand detector 322 of the detector 302 detects a hand from the image data received by the input module 301 (S703). The face detector 321 of the detector 302 detects a face from the image data received by the input module 301 (S704).

The face detector 321 determines whether a face has been actually detected from the image data at S704 (S705). When it is determined that a face has not been detected (No at S705), the procedure shifts to S707.

When the face detector 321 has detected a face (Yes at S705), it detects a region in the face (a part of the face, e.g., eye, eyebrow, mouth, and nose) from the image data (S706).

Thereafter, the determination module 303 determines whether a hand and a region in a face have been detected (S707). When a hand and a region in a face have not been detected (No at S707), the enlarged display is not performed, and the processing is finished while normal display is continued.

When a hand and a region in a face have been detected (Yes at S707), the determination module 303 determines whether the image data is to be enlarged and sets the determination result (S708). The details of the processing will be described later.

The display controller 306 determines whether the enlargement control is necessary based on the enlargement control flag (S709). When the display controller 306 determines that the enlargement control is not necessary (No at S709), the enlarged display is not performed, and the processing is finished while normal display is continued.

When the display controller 306 determines that the enlargement control is necessary (Yes at S709), it enlarges and displays the image data at a display magnification for enlargement display that is higher than a normal display magnification (S710).

The flowchart described above exemplifies the case in which a hand is detected and then a face is detected. However, the detection order is not limited thereto, and a face may be detected before a hand is detected, or a hand and a face may be detected at the same time. In the processing procedure described above, an area containing the region in the face and the hand is enlarged and displayed.

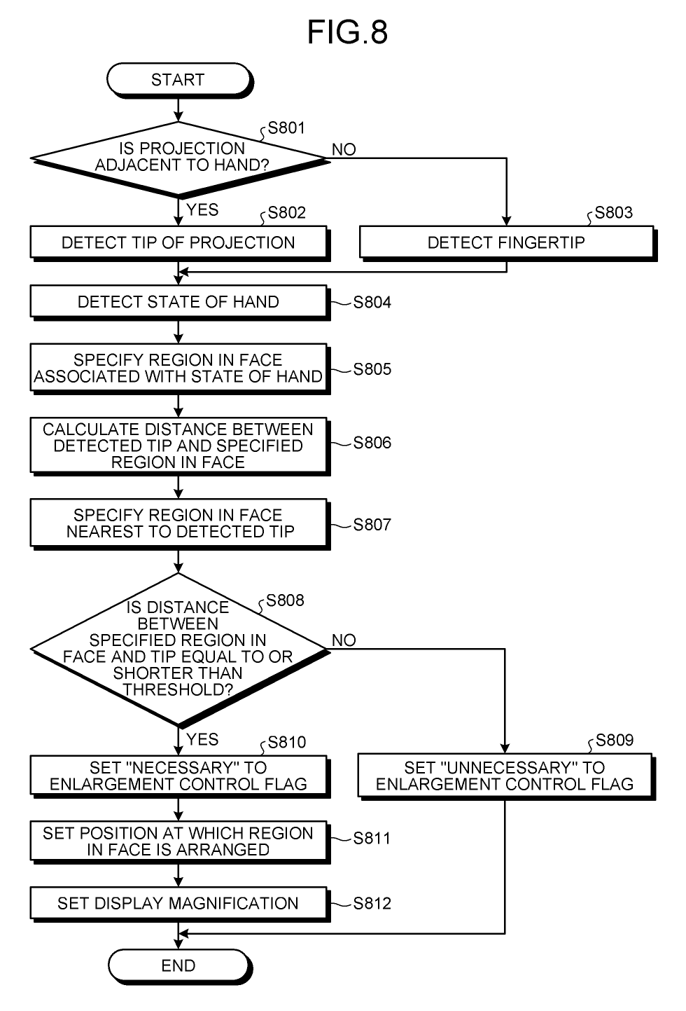

Subsequently, the method of determining whether the image data is to be enlarged at S708 will be described concretely. The following will describe the processing of determining whether the image data is to be enlarged in the television broadcasting display device 100 of the embodiment. FIG. 8 is a flowchart illustrating the procedure of the above-mentioned processing in the television broadcasting display device 100 in the embodiment.

First, the hand detector 322 further determines whether a projection is adjacent to the hand (to the degree that it is considered that the hand holds the projection) (S801). When the hand detector 322 determines that the projection is adjacent to the hand (Yes at S801), it detects a tip of the projection (S802). When the hand detector 322 determines that the projection is not adjacent to the hand (No at S801), it detects a fingertip (S803). In the embodiment, the projection adjacent to the hand is considered to be a cosmetic product held in the hand such as an eyebrow pencil or a lipstick.

Next, the hand detector 322 detects a concrete state of the hand (S804). The determination module 303 specifies, with reference to the enlargement control database 312, a region in a face associated with the detected state of the hand (S805). Thereafter, the determination module 303 calculates a distance between the specified region in a face and the detected tip (of the hand or the projection) (S806).

The determination module 303 specifies a region in the face nearest to the detected tip (of the hand or the projection) (S807). Thereafter, the determination module 303 determines whether the distance between the specified region in the face and the tip is equal to or shorter than a threshold set for the region (S808). When the determination module 303 determines that the distance is longer than the threshold (No at S808), it sets “(enlargement is) unnecessary” to the enlargement setting flag (S809), and finishes the processing.

When the determination module 303 determines that the distance between the specified region in the face and the tip is equal to or shorter than the threshold set for the region (Yes at S808), it sets “necessary” to the enlargement setting flag (S810).

The position setting module 304 sets the focus position associated with the region in the enlargement control database 312 as a center position for displaying the image data (S811). When the region is an eye, for example, the eye appearing on the image data is set as a center position for enlargement.

Next, the display magnification setting module 305 sets the display magnification (higher than a normal display magnification) associated with the region in the enlargement control database as a display magnification for displaying the image data (S812).

With the processing procedure described above, it is possible to achieve enlargement control of image data in accordance with the positional relation between a region in a face and a hand and the state of a hand.

### First Modification

The embodiment described above exemplifies the case in which the enlargement control of the image data is performed in accordance with the positional relation between a region in a face and a hand and the state of a hand. However, the embodiment does not limit to automatic enlargement control, and the enlargement control may be switched based on voice signals. The first modification will describe a case in which the control is performed further based on voice signals.

The input module 301 receives voice signals from the microphone 233. The determination module 303 determines that the image data is to be enlarged when the condition of the embodiment described above is fulfilled and the voice signals received by the input module 301 are of a certain voice pattern. An example of the certain pattern may be when it is determined by voice recognition that the user has uttered “enlarge”.

Various kinds of control other than enlargement control may be performed through voice. A voice pattern for restoring an original display magnification (“restore”, for example) and a voice pattern for continuing a current display magnification (“keep”, for example) are registered preliminarily. When the voice signals received by the input module 301 are of the registered voice pattern, the display controller 306 can achieve control of enlarging and reducing various kinds of image data in accordance with the detected voice signals.

Furthermore, other kinds of control may be performed using voice as a command. For example, when the display controller 306 performs enlargement control and then the input module 301 receives a voice pattern of “larger”, etc., the display controller 306 further performs enlargement control on the image data. When the input module 301 receives a voice pattern of “restore”, etc., the display controller 306 performs control so that the image data is displayed at an immediately previous display magnification.

### Second Modification

The embodiment and the first modification described above describe the case in which the area containing a region in a face and a hand is enlarged so that the user applies makeup onto the face. However, the object to be enlarged is not limited to a region in a face. For example, letters of a label attached on an article is so small that an elderly person may have difficulty of recognizing them. The second modification will describe a case in which when an image of an article is acquired by the camera 101, the display of the article is enlarged.

The detector 302 detects a hand and an article, instead of a face, from image data received by the input module 301.

When the detector 302 have not detected a face and have detected a hand and an article, the determination module 303 determines that the image containing the article is to be enlarged if the distance between the image of the article and the hand is shorter than a threshold set for enlargement of the article. The position setting module 304 sets a position at which the article appears as the center of focusing. Moreover, the display magnification setting module 305 sets a display magnification set for enlargement of the article.

In this manner, when the article and the hand of a person are displayed on the image data and the article and the hand are adjacent to each other (the distance between the article and the hand is shorter than a threshold set for enlargement of the article), the display controller 306 switches the image data to one containing the article at a display magnification set for enlargement of the article that is higher than a normal display magnification, and displays such image data.

Conventionally, when a user is wearing a contact lens on or making up, both hands are often occupied, making it bothersome to bring a mirror to the vicinity of the face. Moreover, when the user performs fine manual operation while viewing a mirror, he or she has difficulty in view without magnification.

Thus, in the embodiment and the modifications described above, when manual operation is performed, an area to which attention is paid for the needs is focused, and enlarged or reduced. Thus, it is possible to appropriately achieve control of focusing, enlargement, reduction, etc., depending on the user's intention even when the hands are occupied.

Therefore, the television broadcasting display device 100 of the above-described embodiment can reduce an operational load, and reduce operation errors, etc., by visual confirmation of an enlarged screen. Moreover, the electronic device, the method, and the computer program product according to one embodiment of the present invention can reduce operation loads of when the size of the image data is enlarged and displayed.

The embodiment exemplifies the case in which the electronic device is applied to the television broadcasting display device. However, the electronic device is not limited to the television broadcasting display device, and may be applied to a smartphone and a tablet terminal, for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive an image acquired by a camera; and
a display controller configured to display an image received by the receiver at a first display magnification, and to display, if a first image received by the receiver comprises both an image of a hand and an image of a region in a face, the first image at a second display magnification higher than the first display magnification.

2. The electronic device of claim 1, wherein
the display controller displays, if a distance between the hand and the region in the face is longer than a first threshold, a second image containing the hand and the region in the face at the first display magnification, and
the display controller displays, if the distance between the hand and the region in the face is equal to or shorter than the first threshold, the second image containing the hand and the region in the face at the second display magnification.

3. The electronic device of claim 1, wherein
the display controller displays, if a distance between the hand and a first region in the face is shorter than a second threshold, a second image containing the hand and the first region in the face at a third display magnification, and
the display controller displays, if a distance between the hand and a second region in the face is shorter than a third threshold, the second image containing the hand and the second region in the face at a fourth display magnification that is different from the third display magnification.

4. The electronic device of claim 1, wherein the display controller further displays, if a distance between an image of an object and the hand of the person is shorter than a fourth threshold, a second image containing the object at a fifth display magnification that is higher than the first display magnification.

5. The electronic device of claim 1, further comprising:
a voice detector configured to detect voice signals, wherein
the display controller is configured to switch, if the voice detector detects a first voice signal while the hand and the region in the face of the person are displayed on the first image, the first image to a second image containing the hand and the region in the face, and to display the second image at the second display magnification.

6. A method of displaying an image by an electronic device comprising:
receiving an image acquired by a camera; and
displaying an image received at the receiving at a first display magnification, and displaying, if a first image received at the receiving comprises both an image of a hand and an image of a region in a face, the first image at a second display magnification higher than the first display magnification.

7. The method of claim 6, further comprising:
displaying, if a distance between the hand and the region in the face is longer than a first threshold, a second image containing the hand and the region in the face at the first display magnification; and
displaying, if the distance between the hand and the region in the face is equal to or shorter than the first threshold, the second image containing the hand and the region in the face at the second display magnification.

8. The method of claim 6, further comprising:
displaying, if a distance between the hand and a first region in the face is shorter than a second threshold, a second image containing the hand and the first region in the face at a third display magnification; and
displaying, if a distance between the hand and a second region in the face is shorter than a third threshold, the second image containing the hand and the second region in the face at a fourth display magnification that is different from the third display magnification.

9. The method of claim 6, further comprising displaying, if a distance between an image of an object and the hand of the person is shorter than a fourth threshold, a second image containing the object at a fifth display magnification that is higher than the first display magnification.

10. The method of claim 6, further comprising:
detecting voice signals; and
switching, if the first voice signal is detected while the hand and the region in the face of the person are displayed on the first image, the first image to a second image containing the hand and the region in the face, and displaying the second image at the second display magnification.

11. A computer program product having a non-transitory computer readable medium including programmed instructions, wherein the instructions, when executed by a computer, cause the computer to perform:
receiving an image acquired by a camera; and
displaying an image received at the receiving at a first display magnification, and displaying, if a first image received at the receiving comprises both an image of a hand and an image of a region in a face, the first image at a second display magnification higher than the first display magnification.

12. The computer program product of claim 11, wherein the displaying comprises:
displaying, if a distance between the hand and the region in the face is longer than a first threshold, a second image containing the hand and the region in the face at the first display magnification; and
displaying, if the distance between the hand and the region in the face is equal to or shorter than the first threshold, the second image containing the hand and the region in the face at the second display magnification.

13. The computer program product of claim 11, wherein the displaying comprises:
displaying, if a distance between the hand and a first region in the face is shorter than a second threshold, a second image containing the hand and the first region in the face at a third display magnification; and
displaying, if a distance between the hand and a second region in the face is shorter than a third threshold, the second image containing the hand and the second region in the face at a fourth display magnification that is different from the third display magnification.

14. The computer program product of claim 11, wherein the displaying comprises displaying, if a distance between an image of an object and the hand of the person is shorter than a fourth threshold, a second image containing the object at a fifth display magnification that is higher than the first display magnification.

15. The computer program product of claim 11, further comprising:
detecting voice signals, wherein
the displaying comprises switching, if the first voice signal is detected at the detecting while the hand and the region in the face of the person are displayed on the first image, the first image to a second image containing the hand and the region in the face, and displaying the second image at the second display magnification.
